(19) United States
(12) Patent Application Publication
(10) Pub. No.: US 2015/0139703 A1
(43) Pub. Date: May 21, 2015

(54) BELT,TRANSFER BELT, TRANSFER BELT UNIT, AND IMAGE FORMATION APPARATUS

(71) Applicant: Oki Data Corporation, Tokyo (JP)

(72) Inventor: Takayuki TAKAZAWA, Tokyo (JP)

(21) Appl. No.: 14/548,977

(22) Filed: Nov. 20, 2014

(30) Foreign Application Priority Data
Nov. 21, 2013 (JP) 2013-241221

(51) Int. Cl. G03G 15/01

(52) U.S. Cl. CPC G03G 15/168
USPC 399/302

(57) ABSTRACT

A belt formed of a single resin layer and having cavities within the resin layer. The belt may be a transfer belt that is arranged opposed to an image carrier which carries a developer image on a surface, and in which the developer image is transferred thereon from the image carrier.

### CROSS REFERENCE TO RELATED APPLICATIONS

This application claims priority based on 35 USC 119 from prior Japanese Patent Application No. 2013-241221 filed on Nov. 21, 2013, entitled “BELT, TRANSFER BELT, TRANSFER BELT UNIT, AND IMAGE FORMATION APPARATUS”, the entire contents of which are incorporated herein by reference.

### BACKGROUND OF THE INVENTION

1. Field of the Invention

The disclosure relates to a belt such as a transfer belt, a transfer belt unit using the transfer belt, and an image formation apparatus using the transfer belt unit.

2. Description of Related Art

In general, an image formation apparatus using electrophotography includes a transfer belt. In the case of an intermediate transfer method, a developer image formed on a surface of an image carrier is transferred to a transfer belt (primary transfer), and further transferred to a recording medium (print sheet, for example) (secondary transfer). In the case of a direct transfer method, a developer image formed on a surface of an image carrier is transferred to a recording medium on a transfer belt.

As a transfer belt, those made of a single resin layer of polyimide (PI), polyamide-imide (PAI), or the like, for example, have been known.

However, a transfer belt formed of polyimide or polyamide-imide has a high elastic modulus. Thus, in the process of transferring a developer image on the image carrier to the transfer belt (in the intermediate transfer method), or a process of transferring the developer image on the image carrier to a recording medium on the transfer belt (in the direct transfer method), the developer is subjected to high pressure due to the pressing force between the image carrier and the transfer belt.

In particular, at a central part of thin lines (characters and the like) where the developer is thickened, pressure is more easily concentrated on the developer than at a contour part, which may thus cause plastic deformation of particles (toner particles) of the developer. The occurrence of plastic deformation in the particles of the developer increases the adhesive force of the particles with the image carrier, making transfer to the transfer belt more difficult. As a result, in some cases, an image defect may occur which is a so-called “void defect” that is apart of the low concentration that is generated in a central part of a thin line.

In order to prevent such void defect, a multilayer structured transfer belt has been proposed with an elastic layer provided on the surface of a belt base material, and concavities and convexities formed on the surface by adding a filler to the elastic layer (see Japanese Patent Application Publication No. 2013-25274 (Paragraph 0022, FIG. 2), for example).

### SUMMARY OF THE INVENTION

On the one hand, a cleaning method has been widely used of removing any developer (residual toner) remaining on the surface of a transfer belt by wiping it away with a cleaning blade.

However, on the transfer belt with surface roughness made rougher by concavities and convexities formed on the surface as described above, the developer image easily remains on the surface of the transfer belt, and the residual developer may thus degrade the image quality.

An aspect of the invention is a belt formed of a single resin layer and having cavities within the resin layer.

According to this aspect of the invention, the provision of cavities in the resin layer constituting the belt can enable a distribution of pressure to be applied to the developer. Thus, the occurrence of an image defect involved in the plastic deformation of the developer can be prevented. In addition, since the belt surface can be made smoother, a degradation of the image quality due to the residual developer can be prevented.

### BRIEF DESCRIPTION OF THE DRAWINGS

FIG. 1 is a view illustrating a basic configuration of an image formation apparatus including a transfer belt in a first embodiment of the invention.

FIG. 2 is a view showing a configuration for cleaning the transfer belt in the first embodiment.

FIG. 3 is a perspective view illustrating the transfer belt in the first embodiment, taken out from the image formation apparatus.

FIG. 4 is a view illustrating a cross sectional structure of the transfer belt in the first embodiment.

FIGS. 5A and 5B are expanded views illustrating examples of a shape of a cavity of the transfer belt in the first embodiment.

FIG. 6 is a view illustrating another example of a cross sectional structure of the transfer belt in the first embodiment.

FIG. 7 is a view illustrating a cross sectional structure of a general intermediate transfer belt.

FIG. 8 is a schematic view for illustrating a method of measuring the specularity of a transfer belt.

FIG. 9 is a view illustrating a pattern projection plate to be used in the measurement of the specularity of a transfer belt.

FIG. 10 is a view illustrating a signal waveform to be used in the measurement of the specularity of a transfer belt.

FIG. 11 is a schematic view for illustrating one example of a method of manufacturing the transfer belt in the first embodiment.

FIG. 12 is a view illustrating the size and occupancy of transfer belts in experiment examples 1 to 7.

FIG. 13 is a view illustrating evaluation results such as void defect, durability, passing-through and the like, using the transfer belts in the experiment examples 1 to 7.

FIG. 14 is a view illustrating examples of void defect in images formed on the transfer belt and void defect percentage.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

In the following, embodiments of the invention are described with reference to the drawings.

### (Configuration of an Image Formation Apparatus)

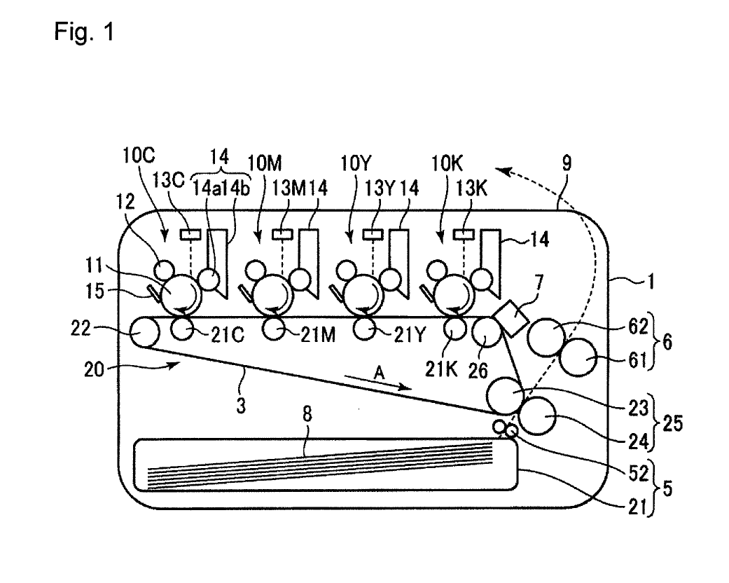

FIG. 1 is a view illustrating a basic configuration of image formation apparatus 1 including transfer belt (intermediate transfer belt) 3 in a first embodiment of the invention. Image formation apparatus 1 is configured to form an image, using four types of developers of black, yellow, magenta and cyan, according to the electrophotography. Here, an intermediate transfer method is used as the transfer method.

Image formation apparatus 1 in the embodiment includes four image drum units (hereinafter referred to as ID units) 10K, 10Y, 10M, 10C, as an image formation unit. ID units 10K, 10Y, 10M, 10C are now aligned along a running direction (to be described below) of transfer belt 3, from right to left in the figure.

LED (light-emitting diode) heads 13K, 13Y, 13M, 13C as an exposure section are arranged so as to be opposed to ID units 10K, 10Y, 10M, 10C. LED heads 13K, 13Y, 13M, 13C are configured to form electrostatic images corresponding to image data of black, yellow, magenta and cyan by irradiating respective photoreceptor drums 11 of ID units 10K, 10Y, 10M, 10C with light.

Since ID units 10K, 10Y, 10M, 10C have a common configuration with the exception of the developer to be used, the ID units are collectively referred to as “ID unit 10” and described. In addition, LED heads 13K, 13Y, 13M, 13C are collectively referred to as “LED head 13” and described.

ID unit 10 has photoreceptor drum 11 as an image carrier, charging roller 12 as a charging member, development unit 14 as a developing section, and drum cleaning section 15.

Photoreceptor drum 11 is configured to have photoreceptor layers (a charge generation layer and a charge transportation layer) stacked on the surface of a cylindrical conductive support. Photoreceptor drum 11 is rotated and driven in a clockwise direction in the figure.

Charging roller 12 is arranged so as to abut the surface of photoreceptor drum 11 and rotates following the rotation of photoreceptor drum 11. A charging voltage is applied to charging roller 12, which uniformly charges the surface of photoreceptor drum 11.

The uniformly charged surface of photoreceptor drum 11 is exposed by LED head 13 as described above, thereby an electrostatic latent image is formed on the surface of photoreceptor drum 11.

Development unit 14 has development roller 14a (a developer carrier) abutting the surface of photoreceptor drum 11 and rotating, and developer holder 14b configured to hold a developer. A development voltage is applied to development roller 14a. By attaching the developer to the electrostatic latent image on the surface of photoreceptor drum 11, development roller 14a forms a developer image (toner image).

In addition, while herein the developer is a one-component developer made of toner, the developer may be a two-component developer made of a toner and a carrier. The developer image formed on the surface of photoreceptor drum 11 is primary transferred to transfer belt 3, as described below.

Drum cleaning section 15 is configured to remove any residual developer remaining on the surface of photoreceptor drum 11 after the primary transfer.

Transfer belt unit 20 including transfer belt 3 is provided to be opposed to the underside of ID units 10K, 10Y, 10M, 10C. Transfer belt 3 is a belt without seams (seamless belt) and an outer periphery thereof is in contact with respective photoreceptor drums 11 of ID units 10K, 10Y, 10M, 10C.

On the side of the inner circumference of transfer belt 3 are arranged primary transfer rollers 21K, 21Y, 21M, and 21C, belt drive roller 22, secondary transfer backup roller 23, and driven roller 26.

Primary transfer rollers 21K, 21Y, 21M, 21C are opposed to respective photoreceptor drums 11 of ID units 10K, 10Y, 10M, 10C, with transfer belt 3 sandwiched therebetween. Primary transfer rollers 21K, 21Y, 21M, 21C have a configuration in which a foamed elastic layer (foamed rubber, for example) is provided around a metal shaft, for example. A primary transfer voltage is applied to primary transfer rollers 21K, 21Y, 21M, 21C and developer images (toner images) on respective photoreceptor drums 11 are primary transfers, transferred to transfer belt 3.

Belt drive roller 22 is rotationally driven by a belt drive motor. Due to the rotation of belt drive roller 22, transfer belt 3 runs (moves around) in a direction as shown by arrow A. Driven roller 26 is configured to provide transfer belt 3 with tension. Primary transfer rollers 21K, 21Y, 21M, and 21C, and secondary transfer backup roller 23, and driven roller 26 rotate following the running of transfer belt 3.

On the side of the outer circumference of transfer belt 3, secondary transfer roller 24 is arranged to sandwich transfer belt 3 with secondary transfer backup roller 23. A secondary transfer voltage is applied to secondary transfer roller 24. Secondary transfer backup roller 23 and secondary transfer roller 24 form secondary transfer section 25 configured to transfer a developer image from transfer belt 3 to recording medium 8.

On the side of the outer circumference of transfer belt 3, cleaning blade 7 is arranged to sandwich transfer belt 3 with driven roller 26. Cleaning blade 7 is configured to wipe away and remove any developer (residual toner) remaining on the surface of transfer belt 3 after the secondary transfer.

These components of transfer belt 3, primary transfer rollers 21K, 21Y, 21M, 21C, belt drive roller 22, secondary transfer section 25 (secondary transfer backup roller 23 and secondary transfer roller 24), and cleaning blade 7 constitute transfer belt unit 20.

Image formation apparatus 1 includes medium supply section 5 configured to house multiple sheets of recording media (print sheet, for example) 8 and carry the recording media one by one to secondary transfer section 25. Medium supply section 5 includes paper feed cassette 51 (medium housing section) configured to house recording media 8 in a stacked state and paper feed roller 52 (medium supply section) configured to pull out recording media 8 one by one from paper feed cassette 51 and carry them to secondary transfer section 25.

In addition, image formation apparatus 1 includes fixing unit 6 configured to fix the developer image, which is transferred to recording media 8 in secondary transfer section 25, to recording media 8 by heat and pressure. Fixing unit 6 has heating roller 61 and pressure roller 62. Heating roller 61 has a heating element such as a halogen lamp therein to heat recording media 8. Pressure roller 62 presses recording media 8 between the pressure roller and heating roller 61. In addition, medium discharge section 9 is configured to discharge recording media 8 on which the developer image is fixed by fixing unit 6, and is provided in image formation apparatus 1.

### (Basic Operation of an Image Formation Apparatus)

When receiving a print instruction and image data from an external computer or the like, image formation apparatus 1 performs an image formation operation as described below. Specifically, image formation apparatus 1 rotates photoreceptor drums 11 for respective ID units 10 (10K, 10Y, 10M, 10C) and belt drive roller 22, applying voltages (charging voltage and developing voltage) to charging rollers 12 and development rollers 14a, respectively.

When photoreceptor drum 11 rotates, development roller 14a rotates due to rotation transmitted from photoreceptor drum 11. In addition, following the rotation of photoreceptor drum 11, charging roller 12 rotates. In addition, due to the rotation of belt drive roller 22, transfer belt 3 runs. Then, following the running of transfer belt 3, primary transfer rollers 21K, 21Y, 21M, 21C, secondary transfer backup roller 23, secondary transfer roller 24, and driven roller 26 rotate.

Charging roller 12 uniformly charges the surface of the photoreceptor drum 11. Then, based on image data of each color, LED head 13 exposes the uniformly charged surface of photoreceptor drum 11 to form an electrostatic latent image. Furthermore, development roller 14a of development unit 14 attaches the developer to the electrostatic latent image on the surface of photoreceptor drum 11 to form a developer image.

Primary transfer voltages are applied to primary transfer rollers 21 (21K, 21Y, 21M, 21C) and the developer images (toner images) on respective photoreceptor drums 11 are transferred to transfer belt 3 (primary transfer). With this, black, yellow, magenta and cyan developer images formed by ID units 10K, 10Y, 10M, 10C are sequentially transferred onto transfer belt 3.

Timed with the arrival of the developer images on transfer belt 3 at secondary transfer section 25, paper feed roller 52 rotates, pulls out recording medium 8 from paper feed cassette 51, and carries it to secondary transfer section 25.

A secondary transfer voltage is applied to secondary transfer roller 24 of secondary transfer section 25. With this, the developer image on transfer belt 3 is transferred to recording medium 8 which is passing through secondary transfer section 25. Recording medium 8 which passes through secondary transfer section 25 is fed to fixing unit 6.

At fixing unit 6, heating roller 61 and pressure roller 62 apply heat and pressure to recording medium 8 to fix the developer image on recording medium 8. Recording medium 8 on which the developer is fixed by fixing unit 6 is discharged to medium discharge section 9.

### (Cleaning Mechanism of a Transfer Belt)

In the following, a cleaning mechanism configured to clean a surface of transfer belt 3 is described. Cleaning blade 7 described above is arranged in the downstream side of secondary transfer section 25 in a running direction (arrow A) of transfer belt 3. In addition, cleaning blade 7 is arranged to sandwich transfer belt 3 with driven roller 26.

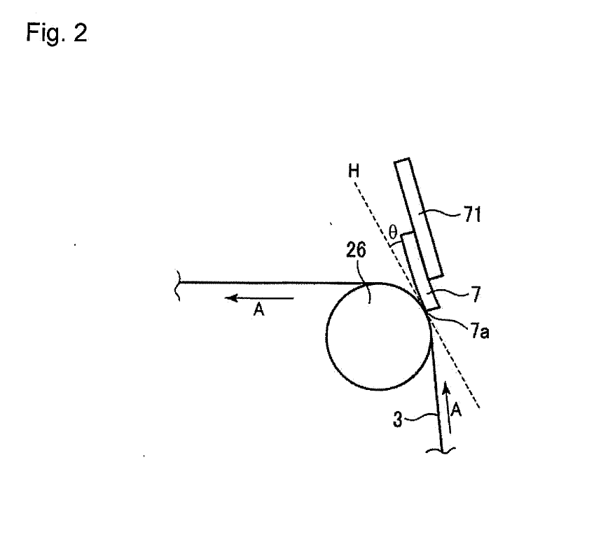

FIG. 2 is a view illustrating a configuration for cleaning the surface of transfer belt 3. Cleaning blade 7 is arranged so that the longitudinal direction thereof is parallel to the width direction of transfer belt 3. A tip area 7a of cleaning blade 7 abuts the surface (outer periphery) of transfer belt 3.

Preferably, cleaning blade 7 is formed of an elastic material whose rubber hardness is in a range of 65 to 100° (JIS-A), for example. Here, urethane rubber having a rubber hardness of 78° (JIS-A) and plate thickness of 2.0 mm is used. Cleaning blade 7 is fixed to the main body of image formation apparatus 1 by support member 71.

A method (blade method) of using cleaning blade 7 made of an elastic material has advantages in that it has an excellent capability of removing any residual developer or foreign matter, and furthermore, it is low priced with a configuration that is simple and compact. As an elastic material, the above-mentioned urethane rubber is preferred in that it has a high degree of hardness, an abundant elasticity and is excellent in wear resistance, mechanical strength, oil resistance, and ozone resistance.

In addition, linear pressure (pressing force) of cleaning blade 7 against transfer belt 3 is preferably 1 to 6 g/mm, and more preferably is 2 to 5 g/mm. When the linear pressure is too small, the adhesiveness of cleaning blade 7 and transfer belt 3 is insufficient, causing poor cleaning. On the one hand, when the linear pressure is too large, cleaning blade 7 comes into a surface contact with transfer belt 3 and the friction resistance increases, which causes a defect such as a burr (deformation of tip area 7a) on cleaning blade 7. Here, the linear pressure is set to 4.3 g/mm.

An abutting angle θ of cleaning blade 7 on transfer belt 3 is preferably 20° to 30°, and more preferably is 20° to 25°. Here, cleaning blade 7 is arranged so that the abutting angle θ is 21°. Note that the abutting angle θ is an angle which cleaning blade 7 makes with a tangential direction (as shown by arrow H in FIG. 2) at a point where tip area 7a of cleaning blade 7 abuts the outer periphery of transfer belt 3.

In the example as illustrated in FIG. 2, although cleaning blade 78 abuts a curved area where transfer belt 3 abuts driven roller 26, the cleaning blade is not limited to such a configuration. For example, cleaning blade 7 may abut a horizontal belt surface (flat surface) of transfer belt 3.

### (Configuration of a Transfer Belt)

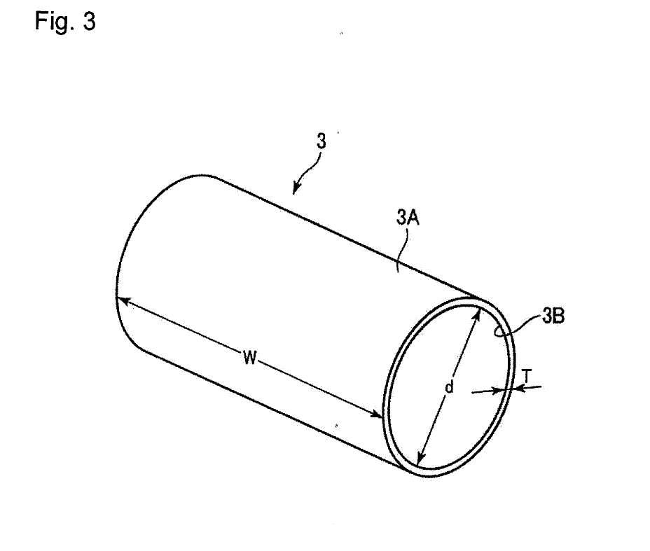

The configuration of transfer belt 3 is described in the following. FIG. 3 is a schematic view illustrating transfer belt 3 taken out from transfer belt unit 20. Transfer belt 3 has an inside diameter d of 254 mm, for example, and a width (length in an axial direction) W of 350 mm. In addition, thickness T of transfer belt 3 is preferably 60 μm or higher and 200 μm or lower. In consideration of the stress applied to an end of transfer belt 3 when it is driven, and its flexibility, it is more preferable that thickness T is 60 μm or higher and 150 μm or lower. Here, the thickness T of transfer belt 3 is set to 80 μm.

From the standpoint of durability and mechanical characteristics, it is preferable that transfer belt 3 has a plastic deformation amount which is a predetermined amount or smaller. Thus, Young's modulus of transfer belt 3 is preferably 2000 MPa or higher, and more preferably is 3000 MPa or higher.

Here, the transfer belt is composed of polyamide-imide (PAI). In addition, carbon black is added to polyamide-imide to exhibit conductivity.

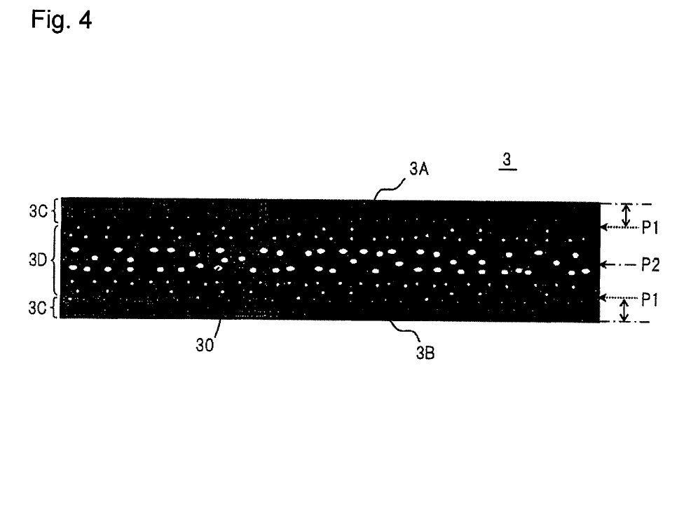

FIG. 4 is a view illustrating a cross sectional structure of transfer belt 3. Transfer belt 3 is formed of a single resin layer and has a multitude of cavities (voids) 30 therein. In particular, a multitude of cavities 30 are formed in the interior in the width direction of transfer belt 3. On the one hand, no cavities 30 are formed in the vicinity of outer periphery 3A and inner periphery 3B of transfer belt 3, or the size of cavities 30 in these areas is smaller than in the interior of transfer belt 3.

Through formation of a multitude of cavities 30 within transfer belt 3 in this manner, pressure applied to the developer between photoreceptor drum 11 and transfer belt 3 is dispersed, which thereby prevents the occurrence of an image defect such as a void defect and the like. In addition, with no cavities 30 being formed in the vicinity of the surface of transfer belt 3, the surface of transfer belt 3 becomes smooth and the cleaning performance by cleaning blade 7 is ensured.

In other words, transfer belt 3 has first layer part 3C where no cavities 30 are formed, in the vicinity of outer periphery 3A and inner periphery 3B, and has second layer part 3D where a multitude of cavities 30 are formed, at the center in the width direction of transfer belt 3. First layer part 3C and second layer part 3D form the single layer of transfer belt 3.

### (Size of Cavities)

The size of cavities 30 of transfer belt 3 is described in the following. To measure the size of cavities 30, “Electron Microscope Model S-2380N” manufactured by Hitachi, Ltd., which is a scanning electron microscope (SEM), is used. After carbon depositing is performed in a cross section of cut transfer belt 3 for 60 seconds, the cross section is observed at 3000-fold magnification with an acceleration voltage being 15 KV.

In the cross section of transfer belt 3 (thickness of 80 μm) which is observed with the above-mentioned SEM, the size of cavities 30 which exist in a unit area (10 μm×10 μm) are measured at position P1 (first position) which is 10 μm from outer periphery 3A and position P2 (second position) which is 40 μm from outer periphery 3A.

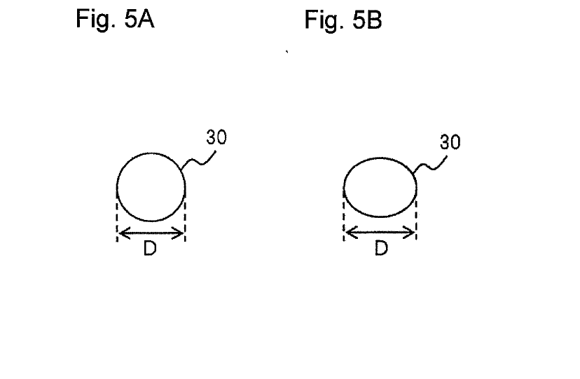

Then, when cavity 30 in the cross section of transfer belt 3 has a completely round shape as illustrated in FIG. 5(A), a diameter of the circle is made a size D of cavity 30. In addition, when cavity 30 has an ellipsoidal shape as illustrated in FIG. 5(B), the length of the long axis of the ellipsoid is made the size D of cavity 30.

Measurement of the size of cavity 30 is performed at three locations each on position P1 and position P2, and average values at each position are obtained. In addition, an average value of the measurement results at positions P1, P2 is made as the cavity size of transfer belt 3.

It is preferable that the size (D) of cavity 30 in the cross section of transfer belt 3 is 0.5 μm or larger and 5 μm or smaller. This is because wear resistance and cracking resistance of transfer belt 3 are reduced and its life may be shortened, if the size of cavity 30 is larger than 5 μm. This is also because the effect of dispersing the pressure applied to a developer becomes insufficient and an image defect such as a void defect and the like cannot be prevented, if the size of cavity 30 is 0.5 μm or smaller.

It is also preferable that cavities 30 of transfer belt 3 become larger at a central part of the width direction and become smaller as they move toward outer periphery 3A and inner periphery 3B. This is because if large cavities are formed in the vicinity (surface layer) of outer periphery 3A or inner periphery 3B of transfer belt 3, those cavities are exposed on outer periphery 3A or inner periphery 3B and become openings, which may increase the surface roughness, resulting in a degraded cleaning performance of cleaning blade 7.

More specifically, it is preferable that size A of cavities 30, existing at position P1 which is 10 μm from outer periphery 3A and inner periphery 3B of transfer belt 3 in the width direction, and size B of cavities 30, existing at position P2 which has distance of 40 μm (½ of thickness T), are in the relationship of A<B. With this, even if openings derived from cavities 30 are generated on outer periphery 3A and inner periphery 3B, the size of the voids can be made 1 μm or smaller and a smooth surface having a specularity (to be described below) of 60 or higher can be formed.

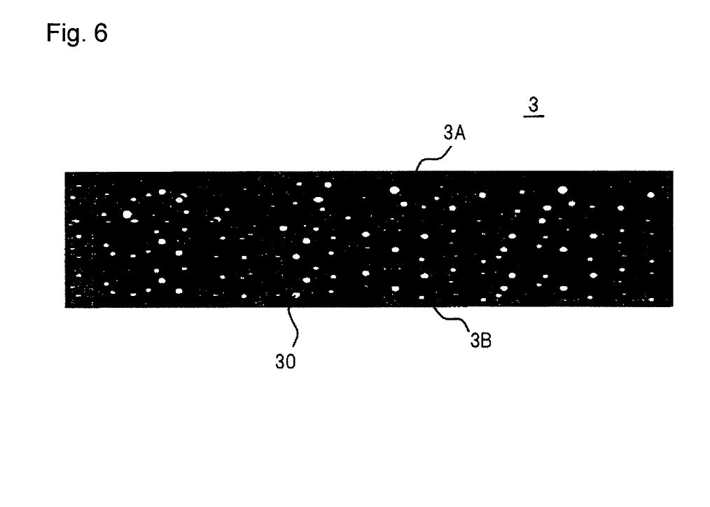

Note that the configuration of transfer belt 3 is not limited to the configuration as illustrated in FIG. 4. For example, as illustrated in FIG. 6, relatively large (preferably 5 μm or smaller) cavities 30 may be equally distributed in an area other than outer periphery 3A and inner periphery 3B of transfer belt 3.

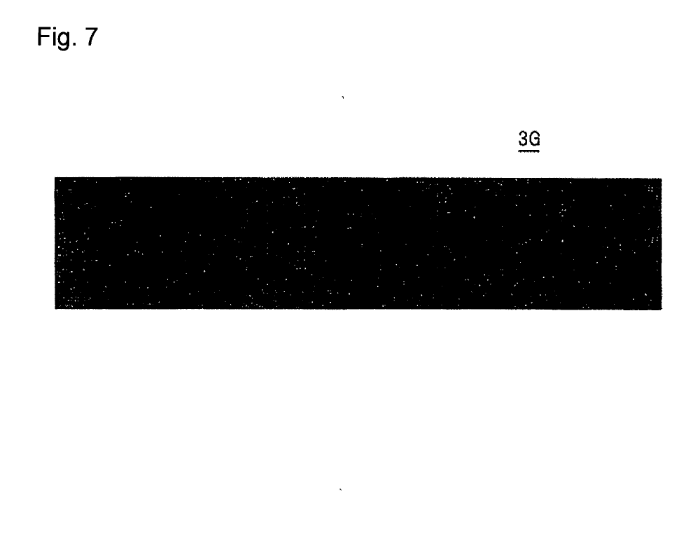

FIG. 7 is a view illustrating a cross sectional structure of general transfer belt 3G. As illustrated in FIG. 7, unlike transfer belt 3 of the embodiment (see FIG. 4 and FIG. 6), no cavities 30 are formed on general transfer belt 3G.

### (Occupancy of Cavities)

Occupancy of cavities 30 is described in the following. In the cross section (see FIG. 4) of transfer belt 3 which is observed with the above-mentioned SEM, an area of cavities 30 in a unit area (10 μm×10 μm) is measured as occupancy of the cavities. Specifically, an image of the cross section of transfer belt 3 which is observed with the above-mentioned SEM is binarized, and the cavities and parts other than the cavities are divided into black and white. Then, the occupancy of the cavities in this cross-section area per unit area (10 μm×10 μm) is calculated, using image processing software “Image-J”.

Measurement of the occupied area is performed at three locations on position P1 which is 10 μm from outer periphery 3A of transfer belt 3 and at three locations on position P2 which is 40 μm from outer periphery 3A. An average value of the occupied area of the six locations is made as the occupancy of cavities 30 of transfer belt 3.

The area occupancy of the cavities in the cross section of transfer belt 3 is preferably 3.0% or higher and 20% or lower. This is because the effect of dispersing pressure applied to a developer becomes insufficient and an image defect such as a void defect and the like cannot be adequately prevented, if the occupancy of cavities 30 is lower than 3.0%. This is also because if the occupancy of cavities 30 is higher than 20%, the strength of transfer belt 3 is degraded and thus becomes fragile, which thus makes it difficult for transfer belt 3 to stably run for a long period of time.

### (Specularity)

Specularity of surfaces (outer periphery 3A and inner periphery 3B) of transfer belt 3 is described in the following. The specularity is an index which shows surface properties in a quantitative manner and is measured by an imaging pattern evaluation method. In addition, a specularity measuring instrument can perform measurements without damaging the surface of transfer belt 3 because it is not in contact with a surface of a measured object with a probe, unlike a probe type roughness measuring instrument. In addition, when compared with the probe type roughness measuring instrument whose measurement range is a few millimeters, the mirror surface measuring instrument has a wide measurement range of 200 mm² and thus is useful as an evaluation method of surface properties.

The specularity of the surface of transfer belt 3 is measured using a specularity meter “SPOTAHS-100S” manufactured by ARC HARIMA CO., LTD (see Japanese Patent Application Publication No. 2007-225969).

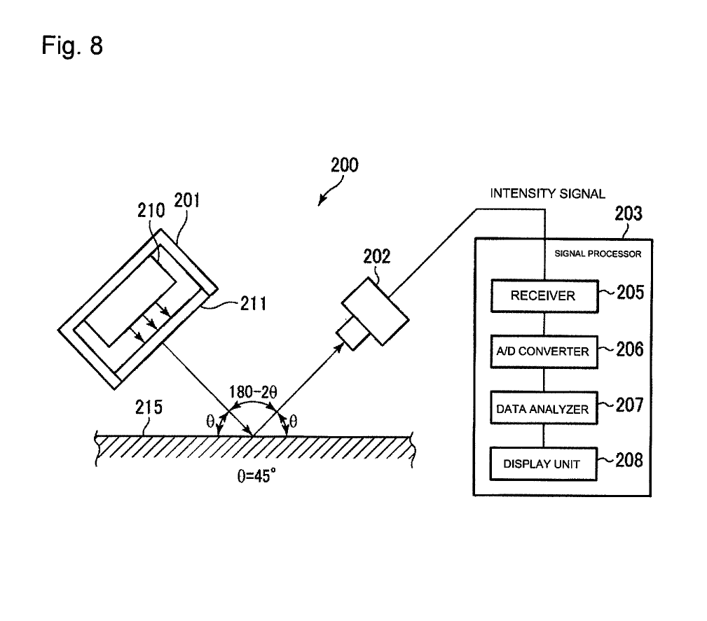

FIG. 8 is a schematic view for illustrating a method of measuring the specularity of transfer belt 3. As illustrated in FIG. 8, specularity measuring instrument 200 includes pattern projection device 201, photoelectric conversion element 202, and signal processor 203.

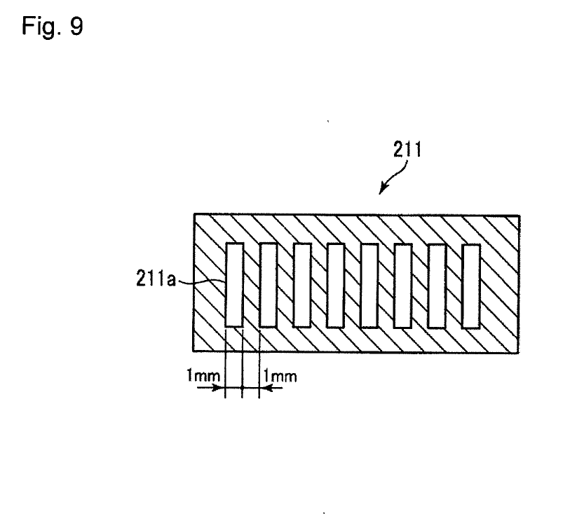

Light source 210 and pattern projection plate 211 are provided in pattern projection device 201. As illustrated in FIG. 9, pattern projection plate 211 is a 0.5-mm thick stainless plate having 1-mm wide apertures 211a aligned. Matting coating is applied to the surface of pattern projection plate 211 so as not to reflect light. Pattern projection device 201 irradiates the measured object surface 215 with light at an angle of θ. While angle θ may be changed depending on the type of the measured object or a measurement method, it is set to 45° here.

Photoelectric conversion element 202 is held so that an optical axis thereof is coplanar with an optical axis of pattern projection device 201 and is at an angle of (180−2θ) degrees. Photoelectric conversion element 202 includes a CCD array in which a multitude of light receivers are arranged linearly (one-dimensional) or two-dimensionally. Photoelectric conversion element 202 images a pattern projected onto measured object surface 215, converts the intensity of the reflected light into an electric signal, and transmits the converted electric signal (intensity signal) to signal processor 203.

Signal processor 203 has receiver 205 configured to receive an electric signal from photoelectric conversion element 202, A/D converter 206 configured to A/D convert the received electric signal, data analyzer 207 as a specularity calculator configured to waveform process the digital signal converted by A/D converter 206, select a maximum value (Max) and a minimum value (Min), and calculate the specularity, and display unit 208 configured to display an analysis result.

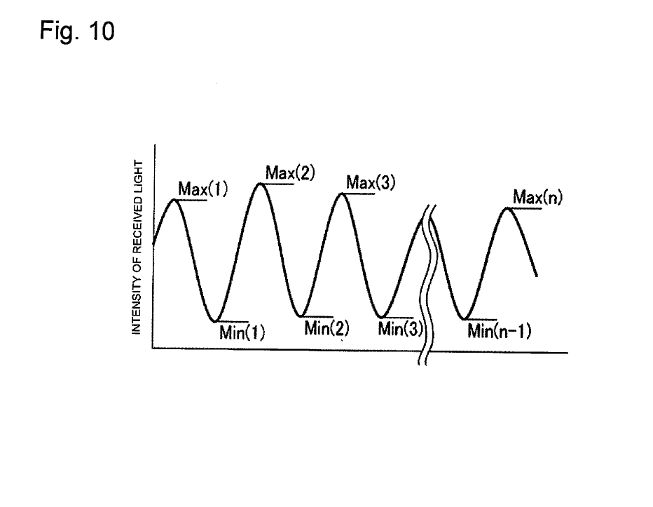

Pattern projection plate 211 is irradiated with parallel rays from light source 210, causing a light-dark pattern of light to be projected onto measured object surface 215. The light-dark pattern projected on measured object surface 215 is imaged by photoelectric conversion element 202, and the intensity of the reflected light is converted into an electric signal, which is then transmitted to signal processor 203. The intensity signal inputted to signal processor 203 is A/D converted by A/D converter 206. FIG. 10 is a graph illustrating the then A/D converted data.

Data analyzer 207 determines an average Max(Avg.) of maximum values Max(1), Max(2) . . . Max(n) of the A/D converted signal waveform and an average Min(Avg.) of minimum values Min(1), Min(2) . . . Min(n) with respective expressions.

Max(Avg.)=ΣMax(n)/nMin(Avg.)=ΣMin(n)/n

From thus determined Max(Avg.) and Min(Avg.), the specularity of the measured object surface is determined with the following expression (1):

Specularity=[{Max(Avg.)−Min(Avg.)}/Max(Avg.)+Min(Avg.)]]×1000 (1)

The specularity thus determined indicates that the larger the specularity is with respect to a specularity of 1000 of an ideal surface, which serves as a reference, the better the surface properties are (that is to say, being smooth), and signifies that the smaller the specularity is, the rougher a surface is.

It is preferable that outer periphery 3A of transfer belt 3 has a specularity of 60 or higher and 200 or lower. The specularity of outer periphery 3A of transfer belt 3 affects the scraping performance, that is to say, the cleaning performance, of residual developer (residual toner) by cleaning blade 7 as illustrated in FIG. 2. This is because the residual developer may pass through between transfer belt 3 and cleaning blade 7 when the specularity is smaller than 60. This is also because when the specularity is 200 or higher, a contact area with transfer belt 3 and cleaning blade 7 becomes large, friction force therebetween increases, and a burr on cleaning blade 7 easily occurs.

Thus, in the embodiment, with the specularity of outer periphery 3A of transfer belt 3 being set within a range of 60 to 200, the residual developer can be scraped away efficiently. Here, the specularity is in a range of 120±10.

Note that inner periphery 3B of transfer belt 3 is not in contact with cleaning blade 7, but is in contact with primary transfer rollers 21K, 21Y, 21M, 21C, belt drive roller 22, secondary transfer backup roller 23, and driven roller 26. Thus, inner periphery 3B of transfer belt 3 is also configured to have a specularity similar to that of outer periphery 3A of transfer belt 3.

### (Static Friction Coefficient)

A static friction coefficient of the surface of transfer belt 3 is described in the following. In the embodiment, the static friction coefficient μs of the surfaces (outer periphery 3A and inner periphery 3B) of transfer belt 3 is adjusted by adding an appropriate amount of fluorine-based or silicone-based water repellent (fluorocarbon, for example) to the resin (polyamide-imide here) which constitutes transfer belt 3.

Specifically, a configuration is such that the static friction coefficient μs of outer periphery 3A of transfer belt 3 is 0.1 or higher and 1.0 or lower. This is because the cleaning action by cleaning blade 7 is not sufficiently exhibited when the static friction coefficient μs is smaller than 0.1. This is also because when the static friction coefficient μs is higher than 1.0, the friction between transfer belt 3 and cleaning blade 7 increases, abnormal noise occurs, or a burr on cleaning blade 7 may be generated.

However, if an additive is added excessively, a phenomenon (bleed out phenomenon) occurs in that as time elapses, an additive floats out on the surface of transfer belt 3. The additive which floats out adheres to photoreceptor drum 11 and causes an image defect. Thus, the static friction coefficient μs is set to the above-mentioned range of 0.1 to 1.0 while paying attention to the amount of additive to be added.

In addition, inner periphery 3B of transfer belt 3 is also configured to have a static friction coefficient μs similar to outer periphery 3A. This is because inner periphery 3B of transfer belt 3 is in contact with primary transfer rollers 21K, 21Y, 21M, 21C, belt drive roller 22, secondary transfer backup roller 23, and driven roller 26 although it is not in contact with cleaning blade 7, as described above.

### (Method of Manufacturing a Transfer Belt)

One example of a method of manufacturing transfer belt 3 in the embodiment is described in the following. Note that the method of manufacturing transfer belt 3 in the embodiment is not limited to the example described below.

Transfer belt 3 is formed of polyamide-imide (hereinafter referred to as PAI) as described above. In order to exhibit conductivity, an appropriate amount of carbon black is blended into polyamide-imide and dispersed in a solution of N-methylpyrrolidone (hereinafter referred to as NMP) to generate material liquid. The dispersion is performed using a ball mill.

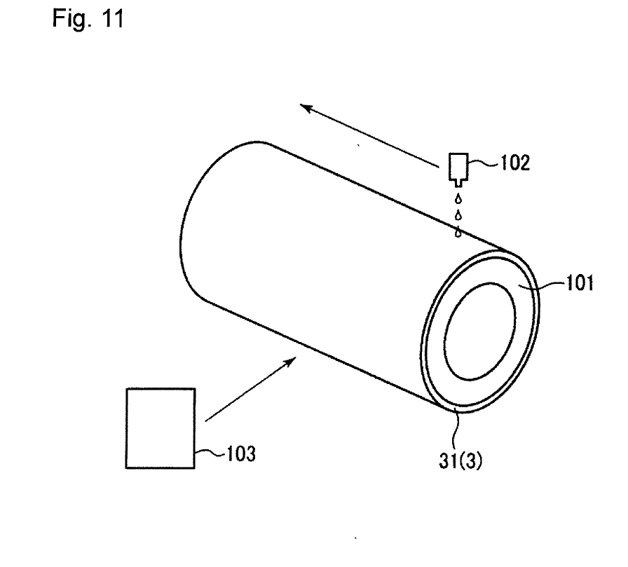

FIG. 11 is a schematic view illustrating one example of a method of manufacturing transfer belt 3. Here, cylindrical die 101 arranged so that an axial direction is horizontal, dispenser 102 configured to drop material liquid onto an outer periphery of die 101, heater 103 configured to heat the material liquid dropped onto the outer periphery of die 101, and a baking furnace are used.

As described above, the material liquid having polyamide-imide dispersed in NMP is discharged from a nozzle of dispenser 102 and dropped onto the surface of die 101 which is rotating. While FIG. 11 illustrates dispenser 102 as dropping the material liquid while traveling in the axial direction of die 101, a multitude of dispensers 102 may be arranged in the axial direction of die 101.

Dropping of the material liquid from dispenser 102 to die 101 and heating (drying of the material liquid) by heater 103 are performed concurrently. Preferably, the heating temperatures are 180 to 230°, for example. Due to the heat of heater 103, NMP of the resin material dropped onto die 101 vaporizes and a layer part made of resin is formed on the surface of die 101.

When die 101 rotates, layer part 31 of a predetermined thickness is formed on the surface of die 101. Here, single-layered transfer belt 3 is formed by turning die 101 multiple times and sequentially stacking layer parts 31 on the surface of die 101.

Then, an adjustment of the pressure in this discharge of the material liquid by dispenser 102 and the temperatures of heating by heater 103 enables a control of the size or quantities of cavities 30 in transfer belt 3.

Specifically, the pressure of discharging the material liquid by dispenser 102 and the temperatures of the heating by heater 103 are adjusted so that cavities 30 do not exist, or the size of cavities 30 is small, when the layer parts (first layer part 3C as illustrated in FIG. 4) in the vicinity of outer periphery 3A and in the vicinity of inner periphery 3B of transfer belt 3 are formed. In addition, the pressure of discharging the material liquid by dispenser 102 and the temperatures of the heating by heater 103 are adjusted so that a multitude of cavities 30 exist, or the size of cavities 30 is large, when a layer part (second layer part 3D as illustrated in FIG. 4) within transfer belt 3 is formed.

With this, a configuration in which cavities exist in the interior of transfer belt 3 and no concavities and convexities appear on the surfaces (outer periphery 3A and inner periphery 3B) can be implemented. In addition, even in a case in which transfer belt 3 is formed by stacking a plurality of layer parts, it can be said that transfer belt 3 is “single layered” because all layers are of an identical material.

In addition, it is also possible to provide a distribution in which large cavities exist at the central part in the width direction of transfer belt 3, slightly smaller cavities exist in an outer area thereof, and almost no cavities exist in the vicinity of the surfaces (outer periphery 3A and inner periphery 3B).

Dropping the material liquid from dispenser 102 onto the surface of rotating die 101 as described above enables a leveling of the surfaces (outer periphery 3A and inner periphery 3B) of transfer belt 3.

When layer parts 31 are stacked on the surface of die 101 and the entire (resin layer) thickness reaches a predetermined thickness, the resin layer is removed from die 101. Then, resin layer 31 is put into a baking furnace, and heated to predetermined curing temperature (250° C., for example). This creates a seamless belt having an inside diameter d (see FIG. 2) of 254 mm. Transfer belt 3 is created by cutting this seamless belt to a predetermined axial length (here 350 mm).

Thickness T of transfer belt 3 is adjusted depending on the amount of the material liquid dropped from dispenser 102, and the like. As described above, the thickness T of transfer belt 3 is preferably 60 μm or larger and 200 μm or smaller (more preferably, 60 μm or larger, 150 μs or smaller), and is 80 μm here.

As it is commonly known, polyamide-imide (PAI) is a polymer obtained by a polymerization of a repeating unit in which an imide group and an amide group are bound with an aromatic ring therebetween. This polyamide-imide can be manufactured by a commonly known manufacturing method, such as a method of polycondensing/imidizing aromatic tricarboxylic acid-anhydride and diamine in an organic solvent under a high temperature, or a method of polycondensing/imidizing aromatic tricarboxylic acid-anhydride and diisocyanate in an organic solvent under a high temperature.

Mechanical properties of transfer belt 3 rely on a structure of an imide side chain, an added amount of an electric conducting agent such as carbon black, molecular weight, or the like. Transfer belt 3 having different mechanical properties can be fabricated by adjusting the reactants or heating temperatures (molding temperatures).

In addition, here, as illustrated in FIG. 11, a single-layered transfer belt 3 is formed by stacking resin layers 31 on the surface of die 101. However, if a resin material which easily forms cavities therein is selected, a resin layer having a smooth surface and cavities only on the inside can be formed in one process.

In addition, a resin material is not limited to polyamide-imide (PAI), and the resin layer may be formed of other resins. For example, it may be formed of a resin such as polyimide (PI), polyether imide (PEI), polyphenylene sulfide (PPS), polyether ether ketone (PEEK), polyvinylidene fluoride (PVDF), polyamide (PA), polycarbonate (PC), polybutylene terephthalate (PBT) and the like, or a resin which mixes multiple kinds thereof.

In addition, while a solvent for dispersing resin materials is determined depending on the kind of resin materials, an aprotic polar solvent is preferred. In particular, in addition to the above-mentioned NMP, an aprotic polar solvent includes N,N-dimethylacetamide, N,N-diethylformamide, N,N-dimethyl sulfoxide, pyridine, tetramethylene sulfone, dimethyltetramethylene sulfone and the like. These may be used singly or as a mixed solvent.

In addition, carbon black, used as an electric conducting agent, includes fast black, channel black, Ketjen black, acetylene black, and the like. These may be used singly or with more than one kind of carbon black combined.

The kind of the carbon black can be selected as appropriate, depending on a targeted conductivity. However, in order to obtain a predetermined resistance, channel black or fast black, in particular, is preferred to be used for transfer belt 3 in the image formation apparatus of the embodiment. In addition, depending on the intended use, carbon black subjected to a treatment to prevent oxidation degradation such as oxidation, craft treatment and the like, or carbon black with an improved dispersibility in a solvent, may be used.

The carbon black content in transfer belt 3 used in the embodiment is preferably 3 to 40% by weight with respect to resin solid content, and more preferably, 3 to 30% by weight in terms of mechanical strength thereof and the like. In addition, a technique to give conductivity is not limited to an electronic conducting approach using carbon black and the like, and a predetermined conductivity may be given by adding an ion conductive agent.

Volume resistivity pv of transfer belt 3 created with the method described above is preferably 10⁶ or higher and 10¹⁴ Ω/cm or lower, and more preferably is 10⁹ or higher and 10¹² Ω/cm or lower. It is generally known that polyamide-imide, to which carbon black is added to exhibit conductivity, has a higher elastic modulus and an increased mechanical strength when compared with polyamide-imide to which no carbon black is added.

However, in order to make the volume resistivity pv lower than 10⁶ Ω/cm, a large amount of electric conducting agent needs to be added. Thus, an amount of electric conducting agent relative to resin becomes excessive, and consequently, transfer belt 3 becomes fragile. In addition, if ion electric conduction is used, a large amount of electric conducting agent needs to be added. Thus, the electric conducting agent floats out to the surface of transfer belt 3 under high temperatures and high humidity, and may adhere to photoreceptor drum 11 and the like. In addition, if the volume resistivity pv is larger than 10¹⁴ Ω/cm, the resin layer may be more highly resistant due to the increased resistance in a low-temperature and low-humidity environment or an increased resistance caused by the passage of time (prominently seen in ion conduction), which causes poor transfer and is thus not preferred.

Toner (developer) used in the embodiment has a main constituent of styrene-acrylic copolymer, which contains paraffin wax, and has an external additive such as silica and the like added, as appropriate, to adjust the electrostatic charge. The average particle size of the toner is 7.0 μm and its sphericity is 0.95. This toner is selected because it has a good transfer efficiency and good release properties when it is fixed, and is excellent in dot reproducibility and resolution in the development. It is contemplated that the toner enables a high-definition image with a high degree of sharpness to be obtained.

### (Evaluation Test)

Using a thus configured transfer belt 3, an evaluation is performed of its void defect and durability properties in a primary transfer process. In the evaluation tests, the transfer belts (thickness of 80 μm) in experiment examples 1 to 7 are used. In the above-mentioned manufacturing methods, the distribution or size of the cavities in these transfer belts are varied through an adjustment of the discharging pressure of dispenser 102 and the heating temperatures.

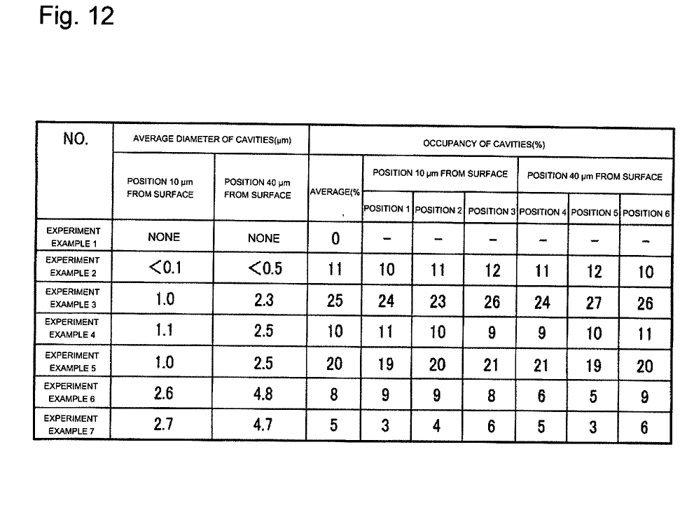

FIG. 12 illustrates average values of the size of the cavities (hereinafter referred to as average diameters of cavities) at the position (position P1 as illustrated in FIG. 4) which is 10 μm from the surfaces (outer periphery 3A, inner periphery 3B), and the average diameters of the cavities at the position (position P2 as illustrated in FIG. 4) which is 40 μm from the surfaces. The method of measuring the average diameters of the cavities is as described above.

In addition, FIG. 12 also illustrates occupancy of cavities 30. A method of measuring the occupancy of cavities 30 is as described above. The occupancy of cavities 30 is measured at three locations (positions 1, 2, 3) which are 10 μm from the surfaces and at three locations (positions 4, 5, 6) which are 40 μm from the surfaces, and the averages of the six locations are determined.

For transfer belt 3 of the experiment example 1, no cavities exist at the positions which are 10 μm from the surfaces or at the positions which are 40 μm from the surfaces. The average of the occupancy of cavities 30 is 0%. Note that for the purpose of illustration, the transfer belt having no cavities is referred to as “transfer belt 3” although it does not belong to the embodiment.

For transfer belt 3 of the experiment example 2, an average diameter of cavities at the positions which are 10 μm from the surfaces is less than 0.1 μm and an average diameter of cavities at the positions which are 40 μm from the surfaces is less than 0.5 μm. An average value of the occupancy of cavities 30 is 11%.

For transfer belt 3 of the experiment example 3, an average diameter of cavities at the positions which are 10 μm from the surfaces is less than 1.0 μm and an average diameter of cavities at the positions which are 40 μm from the surfaces is less than 2.3 μm. An average value of the occupancy of cavities 30 is 25%.

For transfer belt 3 of the experiment example 4, an average diameter of cavities at the positions which are 10 μm from the surfaces is less than 1.1 μm and an average diameter of cavities at the positions which are 40 μm from the surfaces is less than 2.5 μm. An average value of the occupancy of cavities 30 is 10%.

For transfer belt 3 of the experiment example 5, an average diameter of cavities at the positions which are 10 μm from the surfaces is less than 1.0 μm and an average diameter of cavities at the positions which are 40 μm from the surfaces is less than 2.5 μm. An average value of the occupancy of cavities 30 is 20%.

For transfer belt 3 of the experiment example 6, an average diameter of cavities at the positions which are 10 μm from the surfaces is less than 2.6 μm and an average diameter of cavities at the positions which are 40 μm from the surfaces is less than 4.8 μm. An average value of the occupancy of cavities 30 is 8%.

For transfer belt 3 of the experiment example 8, an average diameter of cavities at the positions which are 10 μm from the surfaces is less than 2.7 μm and an average diameter of cavities at the positions which are 40 μm from the surfaces is less than 4.7 μm. An average value of the occupancy of cavities 30 is 5%.

Transfer belts 3 of these experiment examples 1 to 7 are built into image formation apparatus 1, and the formation of toner images with ID units 10Y, 10M for yellow and magenta is started. Specifically, belt drive roller 22 is rotated to start the running of transfer belt 3, and photoreceptor drums of ID units 10Y, 10M are rotated to start the formation of a print pattern.

A print pattern is the letter “T”, 9-point is set for its size, and Times New Roman is set for the font. The letter “T” is selected because it contains vertical and horizontal thin lines. The letter “T” is oriented so that a crossbar is parallel to the travelling direction of transfer belt 3. The print pattern is formed at a temperature of 23° C. and humidity of 50% RH (NN environment).

In ID units 10Y, 10M, charging roller 12 uniformly charges the surfaces of photoreceptor drums 11, and LED heads 13Y, 13M form electrostatic latent images for the letter “T” on the surfaces of the photoreceptor drums 11. In addition, respective development units 14 develop the electrostatic latent images on the surfaces of respective photoreceptor drums 11 to form the toner images for the letter “T”.

Then, transfer voltages are applied to transfer rollers 21Y, 21M, the toner image in yellow of photoreceptor drum 11 for ID unit 10Y is transferred to transfer belt 3, and the toner image in magenta of photoreceptor drum 11 for ID unit 10M is transferred thereon.

After the toner images in yellow and magenta (specifically, red) are transferred to transfer belt 3, the running of transfer belt 3 is stopped and transfer belt 3 is taken out from image formation apparatus 1. The toner image of the letter “T” in red which is formed on the surface (outer periphery 3A) of transfer belt 3 is taken out and the surroundings thereof are enlarged at 100-fold magnification using a stereomicroscope. The toner image is photographed to evaluate the state of void defect.

Void defect refers to a state in which toner does not exist at a location where it should exist, and a part of an image is thus lacking. The toner image of the letter in red, which is a second color (yellow and magenta), is used because a second color has a thicker toner image on transfer belt 3 than a single color, and pressure is thus more easily concentrated on the toner between photoreceptor drum 11 and transfer belt 3 (therefore, void defect easily occurs).

The image photographed by the stereomicroscope (at a 100-fold magnification) as described above is binarized to calculate a void defect percentage (%). Void defect percentage (%)=(area of void defect)/(area of the letter “T” when there is no void defect)×100

The void defect percentage indicates that the smaller it is, the better is the transfer performance. When the void defect percentage is 5% or lower, it is determined that the transfer performance is good. In addition, when the void defect percentage is 10% or lower even if it is 5% or higher, it is determined that the transfer performance is at the level without any problem in practice.

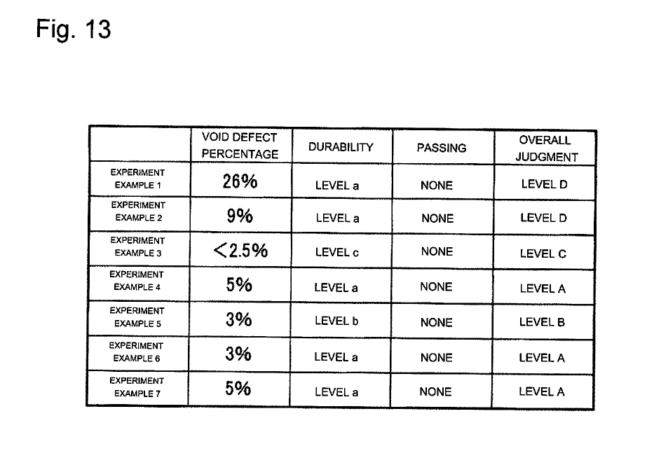

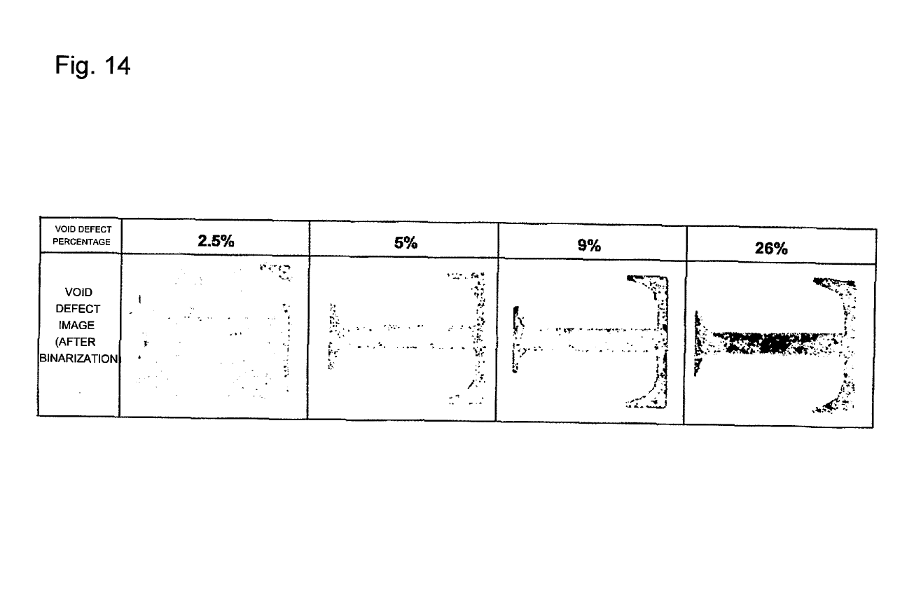

FIG. 13 illustrates the calculation results of the void defect percentage based on the photographed images, for the experiment examples 1 to 7, respectively. In addition, FIG. 14 illustrates the calculated void defect percentages and corresponding void defect states. FIG. 14 illustrates parts where the void defect occurs in black.

From the evaluation results illustrated in FIG. 13, it is seen that in the case in which transfer belt 3 has cavities 30 therein (experiment examples 2 to 7), the void defect percentage is substantially improved when compared with the case in which transfer belt 3 has no cavities 30 (experiment example 1).

It is also seen that in the case in which the average diameter of the cavities of transfer belt 3 is 0.5 μm or larger (experiment examples 3 to 7), the effect of improving the void defect percentage is greater when compared with the case in which the average diameter of the cavities is 0.5 μm or smaller, and thus the transfer performance is good (the void defect percentage is 5% or lower).

### (Durability)

An evaluation of durability of transfer belt 3 is described in the following. In the evaluation of durability, PPC (Plain Paper Copy) sheets are used as recording medium 8 at a temperature of 23° C. and humidity of 50% RH (NN environment) to print 1.5-mm wide horizontal band patterns (stripe patterns in a direction orthogonal to the printing direction). A job to pause once every time three sheets are printed (3P/J) is performed. At an initial time, and when printing of 50K sheets, 100K sheets, and 200K sheets ends, the surface of transfer belt 3 is observed to check whether or not there is any crack. Note that K signifies 1,000 sheets.

If a crack occurs on the transfer belt while printing is going on, the printing is stopped at that point in time. FIG. 13 mentioned above also illustrates the evaluation results.

In addition, the evaluation criteria are as follows. A case in which no occurrence of a crack is observed after the printing of 200K sheets is considered the best level a. A case in which a crack occurs on transfer belt 3 during the printing of 150 to 200K sheets is considered level b. A case in which a crack occurs on transfer belt 3 during the printing of less than 50K sheets is considered level c.

In addition, FIG. 13 also shows observation results of toner passing through between cleaning blade 7 and transfer belt 3. The horizontal band patterns printed on the PPC sheets as recording media 8 are observed and a determination on the passing-through of toner is made based on whether contamination adheres to any part other than the pattern parts. As illustrated in FIG. 13, in all of the experiment examples 1 to 7, a passing-through of toner is not observed.

Based on the evaluation results of the void defect and those of durability as described above, an overall judgment is performed. Judging criteria are as follows. A case in which the void defect percentage is 5% or lower and no occurrence of a crack is observed on transfer belt 3 when the printing of 200K sheets ends is considered the best level A. A case in which a crack occurs on transfer belt 3 when the void defect percentage is 5% or lower and 150 to 200K sheets are printed is considered level B. A case in which a crack occurs on transfer belt 3 when the void defect percentage is 5% or lower and less than 150K sheets are printed is considered level C. A case in which the void defect percentage exceeds 5% even though no occurrence of a crack is observed on transfer belt 3 when the printing of 200K sheets ends is considered level D.

From FIG. 13, in the experiment examples 4, 5, 6, 7, the overall judgment is good, such as a level A or level B. From this, it is learned that transfer belts 3 (experiment examples 4, 5, 6, 7) which meet the conditions that the size of cavities 30 is in the range of 1.0 to 5.0 μm and the occupancy of cavities 30 is 20% or lower is most preferable in that transfer belts 3 can prevent void defect of an image and maintain the durability of transfer belts 3.

### (Consideration)

The results described above can be obtained for the following reasons: Void defect in an image is attributable to plastic deformation of developer particles (toner particles) as they are pressure welded between photoreceptor drum 11 and transfer belt 3 when an developer image is transferred from photoreceptor drum 11 to transfer belt 3.

In particular, since pressure is more concentrated near the center of the character (thin lines) where the developer is thickened than at the contour parts of the characters, pressure applied to the developer particles is large and plastic deformation easily occurs. Plastically deformed developer particles increase the force of adhesion with photoreceptor drum 11. The increased force of adhesion due to the plastic deformation does not return even by the release of pressure. Consequently, the adhesion force of the developer particles and photoreceptor drum 11 becomes larger than the coulomb force applied to the developer particles by the transfer electric field, thus making it difficult for a developer image to be transferred to transfer belt 3.

On the one hand, around the contour part of the characters (in the neighborhood of the outer circumference), since the pressure is dispersed to outside of the characters, no plastic deformation of the developer particles occurs. Thus, even if the adhesion force of the developer particles and photoreceptor drum 11 increases due to the pressure, it returns to the original state when the pressure is released. Therefore, the developer particles at the contour part of the character are easily transferred to the transfer belt by the transfer electric field.

Consequently, near the center of the character, an area where the developer concentration is low (or no developer exists) is generated, causing void defect. In particular, for the second color such as red, since developer images are stacked, the pressure does not easily disperse near the center of the character. It is thus believed that the void defect becomes remarkable.

In contrast, since transfer belt 3 of the embodiment has cavities 30 therein, transfer belt 3 can absorb and disperse any pressure applied to developer particles between photoreceptor drum 11 and transfer belt 3. Consequently, it is believed that even in a part such as the central part of the character (thin lines) where the pressure is easily concentrated, the void defect can be prevented efficiently.

In addition, in the case in which transfer belt 3 has no cavities (experiment example 1), it is believed that the void defect percentage is high, such as 20% or higher, since transfer belt 3 cannot sufficiently disperse the pressure applied to the developer. In addition, while the effect of improving the void defect percentage can be seen in the case in which the cavities are small (experiment example 2), it is believed that the effect of improvement is smaller than the case in which the cavities are large (experiment examples 3 to 7).

In addition, in the case in which the occupancy of cavities 30 exceeds 20% (experiment example 3), a degradation of the durability of transfer belt 3 is observed. It is believed that the strength of transfer belt 3 is reduced and becomes fragile because with the increasing occupancy of cavities 30, the ratio of resin in transfer belt 3 decreases.

In addition, from the results in FIG. 13, it is learned that if the occupancy of cavities 30 is in the range of 5 to 20% (experiment examples 4, 5, 6, 7), it is possible to prevent void defect without degrading the durability of transfer belt 3. In addition, in the experiment example 7, the occupancy of cavities 30 at measurement positions 1, 5 is 3% and the void defect can be prevented without degrading the durability of transfer belt 3. Therefore, it is believed that it may be determined that the lower limit of the occupancy of cavities 30 is 3%.

In addition, although transfer belt 3 of the embodiment has cavities 30 therein, no gap is generated through which the developer passes to an abutment of transfer belt 3 and cleaning blade 7 because the specularity (glossiness) of the surfaces is 120±10. Thus, it is believed that the cleaning performance is not degraded.

Furthermore, since the static friction coefficient μs of the surfaces of transfer belt 3 is set to 1.0 or lower, excessive friction force is not given to cleaning blade 7. Thus, it is believed that any stick-slip motion of cleaning blade 7 is prevented and abnormality, such as an abnormal noise or burr, can be prevented.

### Advantage of the First Embodiment

Since the transfer belt in this embodiment has cavities in the interior of a resin layer, the transfer belt can absorb and disperse any pressure applied to developer particles between photoreceptor drum 11 and transfer belt 3. Consequently, it is possible to prevent void defect of an image due to the concentration of pressure on developer particles and to provide good images.

In particular, since cavities are formed within the transfer belt rather than in the vicinity of the surfaces of the transfer belt, it is possible to reduce concavities and convexities on the surfaces of the transfer belt and thus to have a smoother surface with a specularity (glossiness) from 60 to 200. Accordingly, any residual developer on the transfer belt can be cleaned by the cleaning blade.

Specifically, both improvement of the image quality through prevention of the void defect and maintenance of the cleaning performance with the cleaning blade can be satisfied.

In addition, since the transfer belt in this embodiment is formed of a single resin layer, and the configuration is simpler than a transfer belt having a multilayer structure, it has the advantage that manufacturing processes can be simplified.

In addition, in a multilayer structure in which a coating layer is provided on the surface of a belt base material, the resistance increases in the width direction of a transfer belt, causing an image defect such as dust and the like. Furthermore, a reflection state of light on the surface of the coating layer easily fluctuates, thus causing a fluctuation in detection concentration when the developer concentration on the transfer belt is detected by a concentration sensor. In addition, there is a problem in that a crack occurs or resistance increases if the coating layer is thickened.

Since the transfer belt in this embodiment is formed of a single resin layer, it does not cause these problems, and can achieve an improvement of the image quality through prevention of the void defect phenomenon, and maintenance of the cleaning performance.

In addition, in the transfer belt in this embodiment, size A of the cavities at a first position closer to the surfaces (outer periphery and inner periphery) is smaller than size B of cavities at a second position farther from the surfaces (A<B). Therefore, it is possible to make the surfaces smooth to maintain the cleaning performance, while forming cavities within the transfer belt and thereby exhibiting the effect of dispersing the pressure of developer particles.

In addition, in the transfer belt in this embodiment, since the cavity occupancy per unit area in the cross section is 20% or lower, the occurrence of any crack due to a degraded strength of the transfer belt can be prevented.

In particular, in the transfer belt in this embodiment, since the cavity occupancy per unit area in the cross section is in the range of 3 to 20% (more preferably, 5 to 20%), it is possible to prevent the occurrence of any crack due to a degraded strength of the transfer belt, while sufficiently exhibiting the effect of dispersing the pressure applied to the developer particles and thereby preventing the void defect phenomenon.

In addition, although the transfer belt used in the image formation apparatus of the intermediate transfer method is described in this embodiment, the invention is also applicable to the transfer belt used in the image formation apparatus of the direct transfer method.

Note that in the direct transfer method, a transfer belt carries recoding media (sheets), and a developer image is transferred onto the recording media on the transfer from a photoreceptor drum (image carrier). Since the recording media (sheets) intervene between the photoreceptor drum and the transfer belt, a concentration of pressure on the developer particles does not occur more easily than the intermediate transfer method. However, it is not impossible that void defect occurs. Hence, an application of the invention can enable the effect of preventing the void defect phenomenon to be obtained.

In addition, the invention is not limited to the intermediate transfer method or the direct transfer method, and is also applicable to a fixing belt used in a fixing device, for example.

A belt of the invention is applicable to a transfer belt of the intermediate transfer method or the direct transfer method, a fixing belt, and other belts.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A belt formed of a single resin layer and having cavities within the resin layer.

2. The belt according to claim 1 wherein in a cross section of the belt, a first size of the cavities at a first position which is closer to a surface of the belt is smaller than a second size of the cavities at a second position which is farther from the surface of the belt.

3. The belt according to claim 2 wherein
the first position is a position which is 10 μm away from the surface of the belt, and
the second position is a position which is ½ of a thickness of the belt away from the surface of the belt.

4. The belt according to claim 1 wherein
in the cross section of the belt, the belt includes a first layer part where the cavities are not formed, in an area including the surface of the belt and a second layer part where the cavities are formed, in an area including the center of the belt, and the first layer part and the second layer part constitute the single resin layer.

5. The belt according to claim 1 wherein
the surface of the belt is a smooth surface, and
the belt includes the cavities more inside the belt than the surface of the belt.

6. The belt according to claim 1 wherein
a size of the cavities is 5.0 μm or smaller.

7. The belt according to claim 6 wherein
the size of the cavities is 0.5 μm or larger and 5.0 μm or smaller.

8. The belt according to claim 1 wherein
an occupancy of the cavities per unit area in the cross section of the belt is 20% or lower.

9. The belt according to claim 8 wherein
the occupancy of the cavities per unit area in the cross section of the belt is 3% or higher and 20% or lower.

10. The belt according to claim 9 wherein
the occupancy of the cavities per unit area in the cross section of the belt is 5% or higher and 20% or lower.

11. The belt according to claim 1 wherein
specularity of the surface of the belt is 60 or higher and 200 or lower.

12. The belt according to claim 1 wherein
a static friction coefficient of the surface of the belt is 0.1 or higher and 1.0 or lower.

13. The belt according to claim 1 wherein
thickness of the belt is 60 μm or higher and 200 μm or lower.

14. The belt according to claim 1 wherein
the resin layer contains at least one from the group consisting of: polyamide-imide, polyimide, polyether imide, polyphenylene sulfide, polyether ether ketone, polyvinylidene fluoride, polyamide, polycarbonate, and polybutylene terephthalate.

15. The belt according to claim 14 wherein
the resin layer further contains carbon black.

16. The belt according to claim 14 wherein
the resin layer further contains at least one from the group consisting of a fluorine-based water repellent and a silicone-based water repellent.

17. A transfer belt wherein
the transfer belt is the belt according to claim 1, and
the transfer belt is arranged opposed to an image carrier which carries a developer image on a surface, and the developer image is transferred thereon from the image carrier.

18. A transfer belt wherein
the transfer belt is the belt according to claim 1, and
the transfer belt is arranged opposed to an image carrier which carries a developer image on a surface of the image carrier and opposed to a conveyance path of recording media, such that the transfer belt carries the developer image primary transferred from the image carrier on the surface thereof, and allows the developer image, which is primary transferred to the surface thereof, to be secondary transferred to the recording media.

19. A transfer belt unit comprising:
the belt according to claim 1 as a transfer belt and arranged opposed to an image carrier which carries a developer image on a surface and opposed to a conveyance path of recording media; and
a primary transfer section configured to transfer the developer image on the image carrier, from the image carrier to the transfer belt.

20. An image formation apparatus comprising:
the transfer belt unit according to claim 19; and
a secondary transfer section configured to secondarily transfer the developer image, which is primarily transferred to the transfer belt of the transfer belt unit and to the recording media to be conveyed on the sheet conveyance path.
